(19) United States
(12) Patent Application Publication
(10) Pub. No.: US 2014/0236958 A1
(43) Pub. Date: Aug. 21, 2014

(54) EVOLVING METADATA

(71) Applicant: Robert L. Vaughn, Santa Clara, CA (US)

(72) Inventor: Robert L. Vaughn, Santa Clara, CA (US)

(21) Appl. No.: 13/977,566

(22) PCT Filed: Dec. 15, 2011
(86) PCT No.: PCT/US11/65146

§ 371 Date: Mar. 19, 2014

(51) Int. Cl. G06F 17/30

(52) U.S. Cl. CPC G06F 17/3012; G06F 17/30321; G06F 17/30424
USPC 707/741; 707/736

(57) ABSTRACT

Described herein are techniques related to inferring context information for a piece of content. A client context agent infers the context information by associating the piece of content with information in the computing environment. The association may be made in response to a user interaction with the piece of content in an application, and the information in the computing environment is external to the application. For example, if a user sends an email, the client context went may use a keyword analysis to associate the email with a web page that is open concurrently, and then embed as evolving metadata the Uniform Resource Identifier (URI) of the web page in the email. This Abstract is submitted with the understanding that it will not be used to interpret or limit the scope or meaning of the claims.

### BACKGROUND

One of the great challenges in computing is leveraging information in unstructured data. Structured data is information that exists, for example, within databases, metadata, XML and other “well described” data systems. Structured data may be defined by a template, a schema, or any other means of constraining allowable types and arrangements of data. Unstructured data is any type of data not so constrained—including most web pages, pictures, email, and documents.

Conventional approaches to leveraging unstructured data involve the analysis of data after it has been created and collected. For example, contemporary search engines attempt to infer the context of a document, such as authorship, by analyzing the keywords that exist within the document. However, a search engine may not be able to accurately reconstruct such context after the fact—a document may not include a byline, the byline may not be accurate, or some authors may have been omitted, etc. Moreover, for many types of context, search engines simply lack the information to even guess at the context of the data.

Even when conventional unstructured documents include metadata, such metadata is limited and unreliable. Almost all conventional metadata is manually entered, and as such it is often sporadic, incomplete, and error-prone. For example, some documents may indicate an author in metadata. However, if it is manually entered, the listed author(s) may be stale or incomplete, if they are listed at all. Moreover, almost all manually entered metadata is entered after the content it describes has been created, significantly increasing the likelihood that something was omitted or even entered incorrectly.

Even metadata that is generated automatically, such as a file time stamp, is of limited value. A file may indicate when it was created or last edited, but this says nothing about individual pieces of content contained within the file. For example, neither of these time stamps indicate when a particular piece of content was added edited, or the like. Moreover, a time stamp may indicate when a file was rendered, such as when a web server generated an HTML file, not when the content within the file, such as a picture, was created.

Some applications, such as word processors, have a “track changes” feature that automatically saves authorship of individual pieces of content as metadata. However, features like “track changes” merely consider information available to the application, and as such are ignorant to a greater context in which the content was created.

Additionally, a document (i.e. web page) will often contain sub-parts that have an origin completely separate from the target document. Each of those sub-parts (i.e. tables, pictures, blocks of text) may have a context associated with their own origin and evolution.

Inherent in any attempt to organize data, such as search, is the need to know the context in which the data was created. Thus, a strong need exists for techniques to improve the accuracy and completeness of context information stored in metadata.

### BRIEF DESCRIPTION OF THE DRAWINGS

FIG. 1 is a block diagram illustrating an example environment in which evolving metadata may be implemented.

FIG. 2 is a flow chart illustrating an example method for determining context information.

FIG. 3 is a flow chart illustrating an example method for receiving and processing context information.

FIG. 4 is a block diagram illustrating example associations between different applications.

FIG. 5 is an example system that may be utilized to implement various described embodiments.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are techniques related to inferring context information for a piece of content. A client context agent infers the context information by associating the piece of content with information in the computing environment. In one embodiment, the association is made in response to a user interaction with the piece of content in an application, and the information in the computing environment is external to the application. For example, if a user edits a piece of content at a time when a meeting was scheduled, the client context agent may associate the time of the edit with the time of the meeting, and then associate as evolving metadata the list of meeting attendees with the piece of content.

In one embodiment, the system is accepting of non-perfect associations. In one embodiment, the client context agent will err in favor of a mistaken association rather than avoid a possible association, thereby increasing the number of identified associations compared to a content management system. One benefit of including non-perfect associations is greater fidelity with the human style of making associations between thoughts, ideas, things, or events.

The Evolving Metadata system looks at how individuals create and interact with their own data and how associations naturally occur at the time that those associations occur. The design of the Evolving Metadata system is based on the premise that the context, value and meaning of data may best be determined at the time that it is created. Evolving metadata stores how a piece of content relates to other pieces of content, time, people, places, and more. This enables a user to retrieve information related to a piece of content from an instant messenger session, a web page, or a meeting invite, whether or not the information is local, stored on an internal server such as an email or collaboration server, or on the internet, and regardless of the folder structure in which the content or the information is stored in (if any).

In one embodiment, context information is appended to or otherwise associated with a file as a piece of content is interacted with. In this way, the metadata stored in the file evolves over time.

If a file with evolving metadata is copied, all of the context information currently associated with the file is duplicated and stored in the copy. After duplication, each copy of the file may be interacted with in different ways and in different contexts, causing different context information to be appended to each copy. A subsequent integration of the two files may involve integrating the context information.

Moreover, context information may be chained as content from one document is incorporated into another. For example, if a first document contains a table and associated context information indicating who created the table (among other context info), and a user copies the table and pastes it into a second document, the context information associated with the table will also be copied into the second document. In this way, authorship of pieces of content may be traced. For example, the author of the table may query to find what other documents his table has been copied into. Similarly, if a user desires to know the origin of a particular piece of content, this context information will be included with the piece of content, and so it may be immediately determined by inspecting the context information of the piece of content.

In one embodiment, pieces of content associated with evolving metadata may be indexed by a search agent. In addition to indexing keywords contained in the piece of content, the search agent may index and/or draw inferences from context information. For example, if the search agent finds that a particular document is relevant to a search query, it may increase the relevancy of other documents that are contextually linked to the relevant document.

Example Evolving Metadata Environment

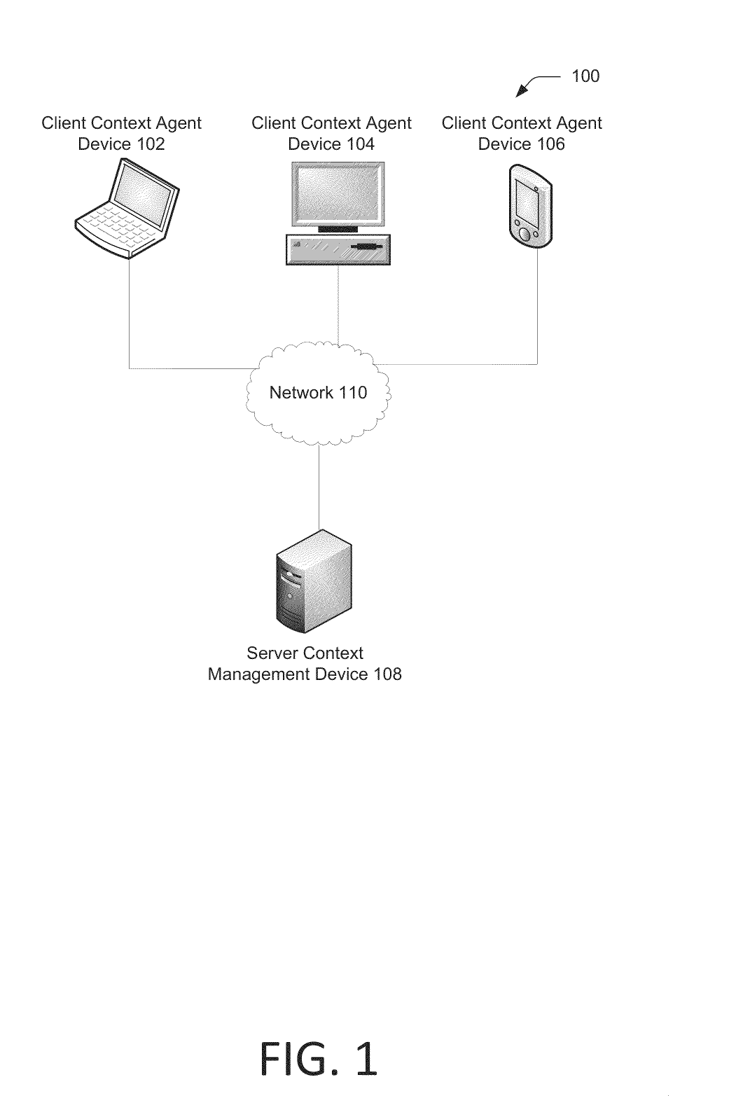

FIG. 1 illustrates an example environment 100 in which evolving metadata may be implemented. In one embodiment, client context agent devices 102, 104, and 106 are connected to server content management device 108 through network 110. Each of client context agent devices 102, 104, and 106 may be, for example, a desktop computer, laptop computer, personal digital assistant, tablet, smart phone, or the like, both physical and virtual. Server context management device 108 may be any server computing device, including a virtualized server, cloud server, or the like.

Client context agent devices 102, 104, and 106 and server content management device 108 may be physically located in a corporate office, logically connected through a corporate internet, or reside independently while being connected through the internet or any other network.

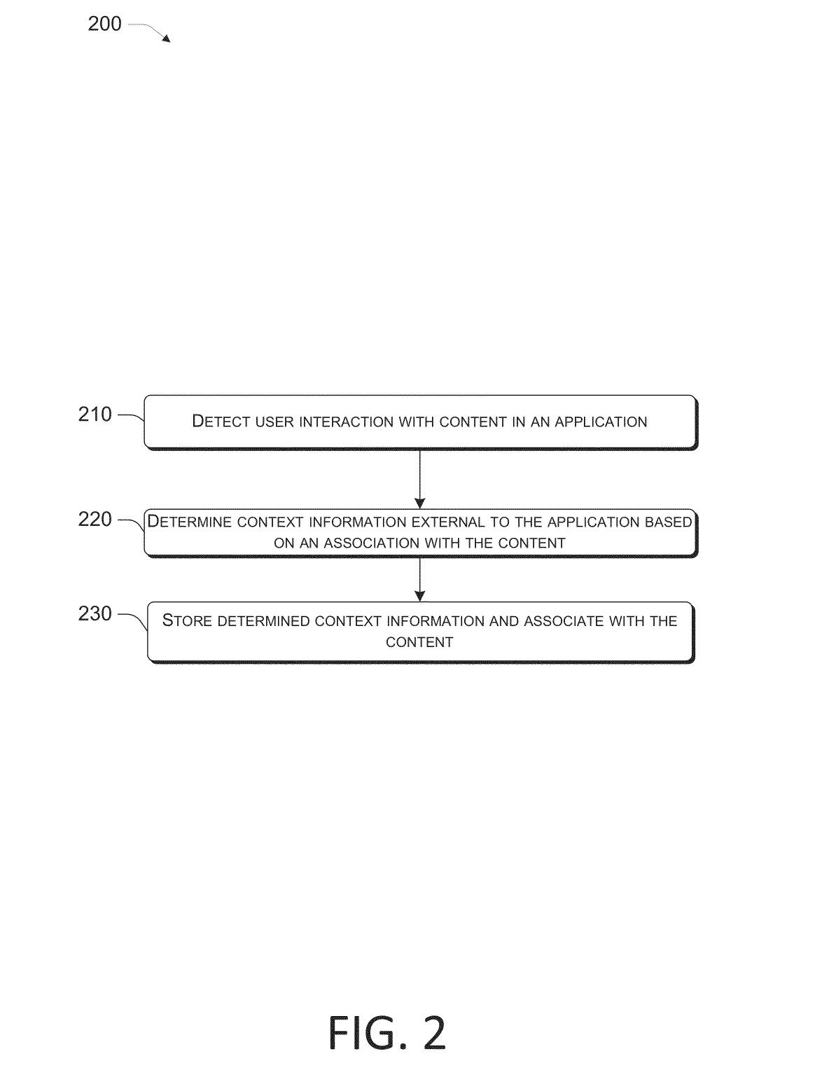

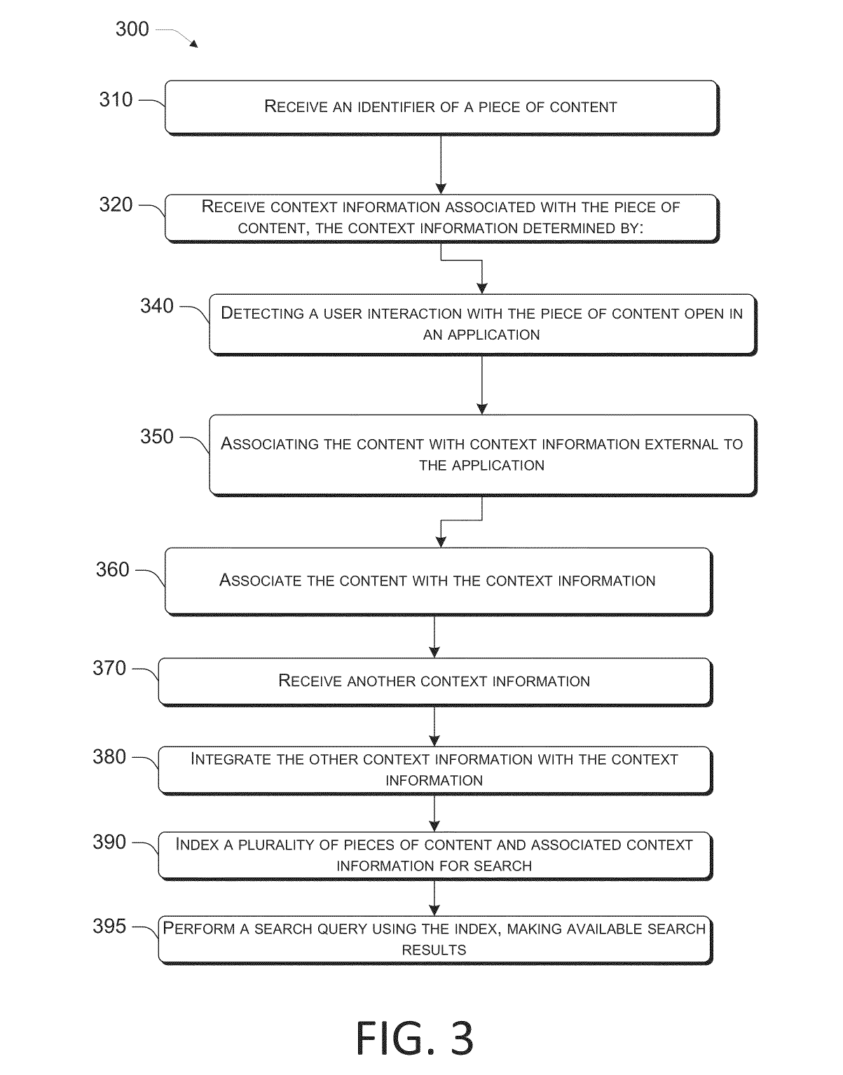

In one embodiment, client context agent devices 102, 104, and 106 may determine context information as discussed below with regard to FIG. 2. Server context management device 108 may, in one embodiment, be configured to receive, aggregate, and search through content and associated context information, as discussed below with regard to FIG. 3.

Example Processes

FIGS. 2 and 3 are flow diagrams illustrating example processes 200 and 300 that implement the techniques described herein for evolving metadata.

FIG. 2 illustrates the example process 200 for determining context information. The process 200 is performed, at least in part, by one of client context agent devices 102, 104, or 106 of FIG. 1. Process 200 may be performed by an operating system component, standalone application software, or an integrated circuit.

As shown here, the process 200 begins with operation 210, detecting user interaction with content in an application. The user interaction may be of any type, such as modifying content in a file, creating a file, embedding content from one document into another, sending a file containing the content, or the like. The user interaction may be received from a pointing device such as a mouse, a keyboard, a voice command, a touch interface, or any other human interface. In another embodiment, the user interaction is generated by automation.

User interaction modifying content in a file may include adding content, editing content, deleting content, pasting in content, and the like. For example, a user may add text to a paragraph, draw a picture, create a table, or paste in a quote from another document.

Embedding content from one document into another may include embedding the content into another document or embedding content from another document into a document the user is working on. For example, the user may attach a word processing document he is working on to an email, or the user may embed a spreadsheet table into a word processing document he is working on.

Examples of sending a file containing the content include sending an email, text message, SMS message, or the like, that contains the content.

At operation 220, context information external to the application is associated with the piece of content. In one embodiment, the context information is determined in response to detecting the user interaction, or as the user interaction is being detected.

In one embodiment, context information is external to the application because it is derived from another application such as a web browser or calendar application, from the operating system, or from an online collaboration tool such as Microsoft Sharepoint®—not from the application in which the user interaction was detected. For example, the context information may include a web page that was open when a user added content to a word processing document. In this case, the web page is external to the word processing document, because it is part of a different application. In another embodiment, context information may be external if it is located in another instance (process) of the application in which the user interaction was detected.

Other types of context information include the identity of the user interacting with the piece of content, a geographic location where the user interaction took place, a network address of the computing device used to perform the user interaction, a team name, a project name, or the like.

Moreover, context information may include a list of message recipients, such as recipients of an email. For example, if the user sent an email with an attachment to Able and Baker, the context information of the email and/or the attachment may be appended to indicate that Able and Baker are associated with the email/attachment. In another embodiment, the context information may include a list of meeting invitees, such as when a user sends (or responds to) a meeting invite that contains a piece of content—the context information of the content may be appended to indicate that the meeting invitees are associated.

In one embodiment, the context information is determined based on an association with content the user interacted with. For example, a web page may be associated with content added to a word processing document if the web page was open at the time the addition was made. However, the association may be stronger if, in addition to being open concurrently, the web page contains keywords similar to keywords in the word processing document. Moreover, the association may be even stronger if the keywords in the web page are similar to keywords in the added content. Any combination of associations may be used to determine whether information external to the application is context information.

Many kinds of associations are contemplated, such as concurrent use by the user. In one embodiment, concurrent use means both the application and the source of the context information are open at the same time, on the same desktop. However, the client context agent may also consider information not located on the desktop, including information in collaboration suites such as Microsoft Sharepoint®, databases, other computer desktops, web pages, and the like.

In one embodiment, the client context agent may determine a strength of association based on how recently the potential context information was accessed. For example, if two web pages are loaded, both with keywords associated with a piece of content in a word processing document, but one of the two web pages was accessed (i.e. retrieved) more recently, then that page is more likely to be associated with the piece of content as context information. Other considerations regarding the strength or an association include whether the context information was “on top” of the desktop (completely visible), partially visible, obscured, or minimized, where “on top” is associated with the highest strength, then partially visible, then obscured, then minimized is associated with the least strength. In general, information is more likely to be considered context information if it is likely the user was considering the information when the user interaction took place.

In another embodiment, an association may be based on keywords shared between the content and information in another application (e.g. web browser, calendar, collaboration suite, etc.). Many algorithms for identifying, categorizing, and comparing keywords are contemplated, as understood by one of ordinary skill in the art. Keywords may be given different weights based on where they are located keywords located in the content the user interacted with are given more weight, and thus are more likely to be associated with a given piece of information, while keywords found throughout the document generally are given less weight. Moreover, instead of keywords, concepts derived from keywords may be used to form an association.

Beyond shared keywords, an association may also be based on shared usernames. For instance, if the user interaction is attaching a document to an email addressed to a co-worker, and another email from the co-worker is open on the user's desktop, the shared username may create an association between the sent email (or the document attached to the sent email) and the email from the co-worker.

At operation 230, the context information is stored. In one embodiment, the context information is stored in a same file as the piece of content. In another embodiment, the context information is stored on a server context management device 108, as discussed below with regard to FIG. 3.

In one embodiment, the piece of content is already associated with context information—context information associated with a previous user interaction. In this case, the instant context information is appended to the existing context information. In this way, the metadata evolves as users interact with the content.

FIG. 3 illustrates the example process 300 for receiving and processing context information. The process 300 is performed, at least in part, by server context management device 108 of FIG. 1.

As shown here, the process 300 begins with operation 310, where an identifier of a piece of content is received. In one embodiment, the identifier comprises a serial number, a Globally Unique Identifier (GUID), URI, or the like.

At operation 320, context information associated with the piece of content is received. The received context information was derived, as depicted in operations 340 and 350 of FIG. 3, as described above with regard to operations 210 and 220 of FIG. 2.

At operation 360 the content is associated with the received context information based on the received content identifier. In one embodiment, when an existing context information exists for the received content identifier, the received context information is appended to the existing context information. In an embodiment, the existing context information and the context information are stored in a table of context information associated with the received content identifier.

At operation 370, another context information associated with the content is received and stored. In one embodiment, the other context information is associated with the same piece of content. In one embodiment, the other context information is associated with a copy of the piece of content.

At operation 380, the other context information is integrated with the context information. In one embodiment, the other context information is integrated by appending it to the context information.

At operation 390, a plurality of pieces of content and associated context information are indexed in preparation for search. Additionally or alternatively, the indexing is in preparation for determining the history of a piece of content, or the reach of a piece of content as it has been copied from document to document.

At operation 395, the server content management device performs a search using the index. In one embodiment, the search uses context information to return documents in the search result that would have been missed by traditional keyword analysis. For example, if two documents are associated because there were both edited by invitees of a meeting at the time the meeting was scheduled, and one of the documents but not the other would be included in a keyword only search result, the other document may also be included in the search result based on the shared context information. Specifically, because both documents were edited by invitees of the same meeting, when the meeting was to take place, a search result containing one document is more likely to also return the other document.

Association Illustration

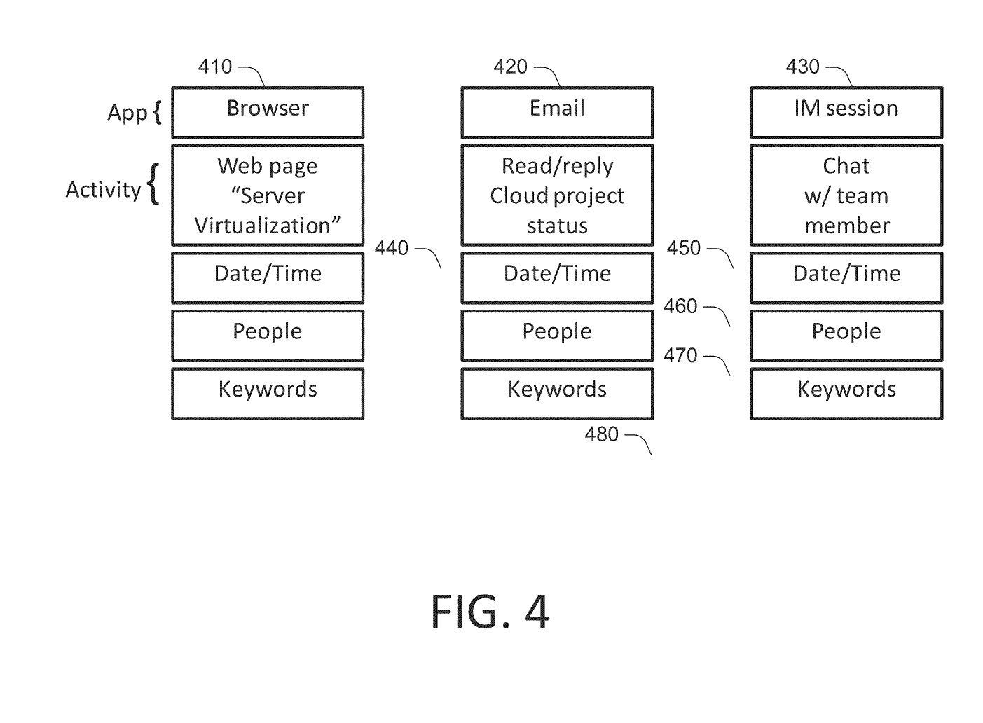

FIG. 4 illustrates associations between different applications.

In one embodiment, browser 410, email application 420, and IM session 430 are open and in use by a user. For example, the browser has open a web page entitled “Server Virtualization”, while the user is reading and replying to a cloud project status and chatting with a team member over instant messenger.

By nature of being open at the same time, browser 410 and email application 420 are associated, as depicted by connection 440. Similarly, email application 420 and IM session 430 are also associated based on being open at the same date and time.

Moreover, the IM session 430 is with one of the people connected to the cloud project status email. This illustrates an association by username. Thus, an association between the email and the instant message is identified, as depicted by connection 460. Finally, keywords in the email match keywords identified in the instant message, creating an association as depicted by connection 470, while keyword in the “Server Virtualization” web page are associated with keywords in the IM session as depicted by connection 480.

In one embodiment, associations are transitive. If an association exists between an email message and an IM session based on share usernames, the IM session may be associated (but not the email message) may be associated with the web page based on key words. In this scenario, the web page is transitively associated with the email message.

Additional and Alternative Implementation Notes

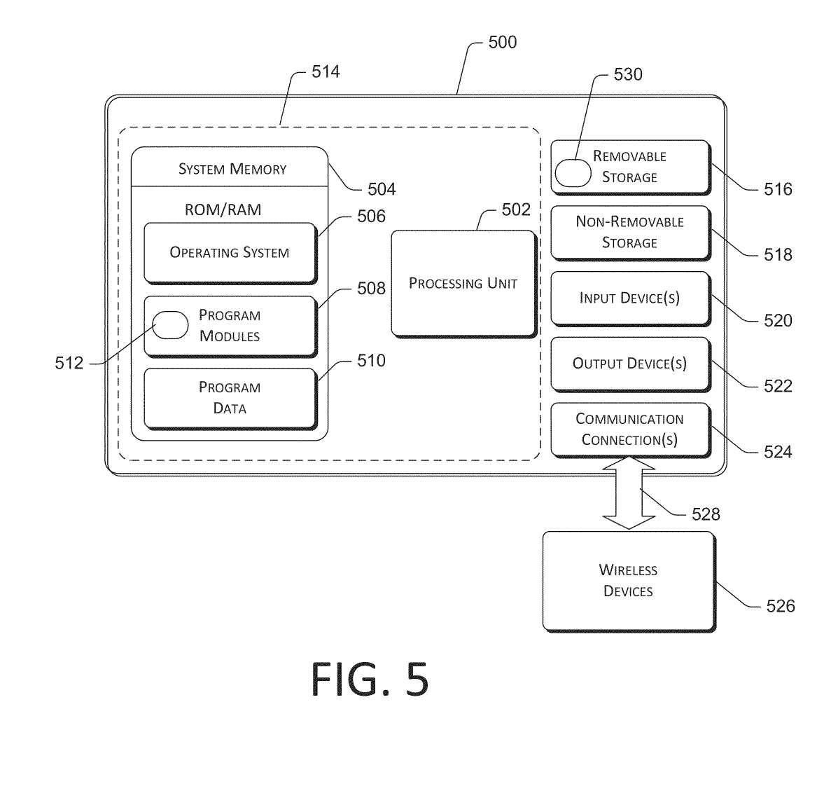

FIG. 5 is an example system that may be utilized to implement various described embodiments. However, it will be readily appreciated that the techniques disclosed herein may be implemented in other computing devices, systems, and environments. The computing device 500 shown in FIG. 5 is one example of a computing device and is not intended to suggest any limitation as to the scope of use or functionality of the computer and network architectures.

In at least one implementation, computing device 500 typically includes at least one processing unit 502 and system memory 504. Depending on the exact configuration and type of computing device, system memory 504 may be volatile (such as RAM), non-volatile such as ROM, flash memory, etc.) or some combination thereof. System memory 504 may include an operating system 506, one or more program modules 508, and may include program data 510. A basic implementation of the computing device 500 is demarcated by a dashed line 514.

The program module 508 may include a module 512 configured to implement the one-tap connection and synchronization scheme as described above. For example, the module 512 may carry out one or more of the method 400 and method 400, and variations thereof, e.g., the computing device 500 acting as described above with respect to the processing unit 102, mobile device 210, mobile device 220 or mobile device 230.

Computing device 500 may have additional features or functionality. For example, computing device 500 may also include additional data storage devices such as removable storage 516 and non-removable storage 518. In certain implementations, the removable storage 516 and non-removable storage 518 are an example of computer accessible media for storing instructions that are executable by the processing unit 502 to perform the various functions described above. Generally, any of the functions described with reference to the figures may be implemented using software, hardware (e.g., fixed logic circuitry) or a combination of these implementations. Program code may be stored in one or more computer accessible media or other computer-readable storage devices. Thus, the processes and components described herein may be implemented by a computer program product. As mentioned above, computer accessible media includes volatile and non-volatile, removable and non-removable media implemented in any method or technology for storage of information, such as computer readable instructions, data structures, program modules, or other data. The terms “computer accessible medium” and “computer accessible media” refer to non-transitory storage devices and include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium that may be used to store information for access by a computing device, e.g., computing device 500, mobile device 210, mobile device 220 and mobile device 230. Any of such computer accessible media may be part of the computing device 500.

In one implementation, the removable storage 516, which is a computer accessible medium, has a set of instructions 530 stored thereon. When executed by the processing unit 502, the set of instructions 530 cause the processing unit 502 to execute operations, tasks, functions and/or methods as described above, including method 300, method 400 and any variations thereof.

Computing device 500 may also include one or more input devices 520 such as keyboard, mouse, per voice input device, touch input device, etc. Computing device 500 may additionally include one or more output devices 522 such as a display, speakers, printer, etc.

Computing device 500 may also include one or more communication connections 524 that allow the computing device 500 to communicate wirelessly with one or more other wireless devices, over wireless connection 528 based on near field communication (NFC), Bluetooth, radio frequency (RF), infrared, or a combination thereof.

It is appreciated that the illustrated computing device 500 is one example of a suitable device and is not intended to suggest any limitation as to the scope of use or functionality of the various embodiments described.

Unless the context indicates otherwise, the term “Universal Resource Identifier” as used herein includes any identifier, including a GUID, serial number, or the like.

In the above description of example implementations, for purposes of explanation, specific numbers, materials configurations, and other details are set forth in order to better explain the present invention, as claimed. However, it will be apparent to one skilled in the art that the claimed invention may be practiced using different details than the example ones described herein. In other instances, well-known features are omitted or simplified to clarify the description of the example implementations.

The inventors intend the described example implementations to be primarily examples. The inventors do not intend these example implementations to limit the scope of the appended claims. Rather, the inventors have contemplated that the claimed invention might also be embodied and implemented in other ways, in conjunction with other present or future technologies.

Moreover, the word “example” is used herein to mean serving as an example, instance, or illustration. Any aspect or design described herein as “example” is not necessarily to be construed as preferred or advantageous over other aspects or designs. Rather, use of the word example is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

These processes are illustrated as a collection of blocks in a logical flow graph, which represents a sequence of operations that may be implemented in mechanics alone or a combination with hardware, software, and/or firmware, in the context of software/firmware, the blocks represent instructions stored on one or more computer-readable storage media that, when executed by one or more processors, perform the recited operations.

Note that the order in which the processes are described is not intended to be construed as a limitation, and any number of the described process blocks may be combined in any order to implement the processes or an alternate process. Additionally, individual blocks may be deleted from the processes without departing from the spirit and scope of the subject matter described herein.

The term “computer-readable media” includes computer-storage media. In one embodiment, computer-readable media is non-transitory. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

Unless the context indicates otherwise, the term “logic” used herein includes hardware, software, firmware, circuitry, logic circuitry, integrated circuitry, other electronic components and/or a combination thereof that is suitable to perform the functions described for that logic.

1-24. (canceled)

25. A method comprising:
detecting a user interaction with a piece of content in an application;
determining a context information external to the application, wherein the context information is associated with the piece of content; and
storing the context information.

26. A method as recited in claim 25, wherein the user interaction with the piece of content includes viewing content, adding content, editing content, deleting content, pasting in content copied from another piece of content, embedding the piece of content in another piece of content, embedding another piece of content in the piece of content, attaching the piece of content to a message, sending the piece of content as a message, creating a file, or saving a file.

27. A method as recited in claim 25, wherein the piece of content is associated with the context information based on shared keywords, shared concepts derived from keywords, shared usernames, or concurrent use by the user.

28. A method as recited in claim 25, wherein the context information includes an identity of the user, a list of message recipients, a list of meeting invitees, a geographic location where the user interaction took place, a network address of a device with which the user interaction took place, a Uniform Resource Identifier (URI) of a document, a team name, or a project name.

29. A method as recited in claim 25, wherein the piece of content is associated with the context information in response to the user interaction, or at the time of the user interaction.

30. A method as recited in claim 25, wherein the determined context information is stored in a same file as the piece of content is stored, or on an evolving metadata server.

31. A method as recited in claim 25, wherein, in an instance where the user interaction occurred during a meeting, the context information includes a list invitees to the meeting.

32. A method as recited in claim 25, wherein, in an instance where the user interaction with the piece of content includes pasting in content copied from another piece of content, the context information includes a Uniform Resource Identifier (URI) of the other piece of content.

33. A method as recited in claim 25, wherein, in an instance where the user interaction includes pasting in content copied from another piece of content, and wherein the other piece of content has already been associated with another context information, adding the other context information to the context information.

34. A method as recited in claim 25, wherein the piece of content was previously associated with a prior context information, and wherein the context information is appended to the prior context information.

35. A method as recited in claim 25, wherein:
the user interaction with the piece of content includes viewing content, adding content, editing content, deleting content, pasting in content copied from another piece of content, embedding the piece of content in another piece of content, embedding another piece of content in the piece of content, attaching the piece of content to a message, sending the piece of content as a message, creating a file, or saving a file;
the piece of content is associated with the context information based on shared keywords, shared concepts derived from keywords, shared usernames, or concurrent use by the user; and
the context information includes an identity of the user, a list of message recipients, a list of meeting invitees, a geographic location where the user interaction took place, a network address of a device with which the user interaction took place, a Uniform Resource Identifier (URI) of a document, a team name, or a project name.

36. A method as recited in claim 25, wherein the context information external to the application is included in a different application.

37. A method as recited in claim 25, wherein, in an instance where the user interaction includes sending a message to one or more recipients, the context information associated with the message includes a list of the one or more recipients.

38. A non-transitory computer-readable medium storing instructions that when executed by a processor perform the method as recited in claim 25.

39. An apparatus comprising:
a processor;
a client context agent executable on the processor to:
detect a user interaction with a piece of content in an application;
determine a context information external to the application, wherein the context information is associated with the piece of content; and
store the context information.

40. An apparatus as recited in claim 39, wherein the piece of content is associated with the context information based on shared keywords, shared concepts derived from keywords, shared usernames, or concurrent use by the user.

41. A client context agent comprising:
means for detecting a user interaction with a piece of content in an application;
means for determining a context information external to the application, wherein the context information is associated with the piece of content; and means for storing the context information.

42. A client context agent as recited in claim 41, wherein the user interaction with the piece of content includes viewing content, adding content, editing content, deleting content, pasting in content copied from another piece of content, embedding the piece of content in another piece of content, embedding another piece of content in the piece of content, attaching the piece of content to a message, sending the piece of content as a message, creating a file, or saving a file.

43. A system comprising:
an apparatus that comprises:
a processor;
a client context agent executable on the processor to:
detect a user interaction with a piece of content in an application;
determine a context information external to the application, wherein the context information is associated with the piece of content;
store the context information; and
an evolving metadata context management server device that performs actions, including:
receiving an identifier of the piece of content;
receiving the context information associated with the piece of content, wherein the context information was determined by the apparatus; and
storing the context information, the identifier of the piece of content, and an association between the context information and the identifier of the piece of content.

44. A system as recited in claim 43, wherein the evolving metadata context management server device further performs actions comprising:
receiving another context information associated with the piece of content; and
appending the other context information with the context information.

45. A system as recited in claim 43, wherein the evolving metadata context management server device further performs actions comprising:
receiving another context information associated with a copy of the piece of content; and
integrating the other context information with the context information.

46. A system as recited in claim 43, wherein the evolving metadata context management server device further performs actions comprising:
receiving the piece of content;
indexing a plurality of pieces of content for search, wherein two or more of the pieces of content are associated with context information, and wherein the indexing is based in part on the context information.

47. A system as recited in claim 43, wherein the evolving metadata context management server device further performs actions comprising:
receiving a search query;
identifying a second plurality of pieces of content based on an index and the search query;
identifying a related piece of content, wherein the related piece of content shares context information with one or more of the second plurality of pieces of content; and
making available search results that include the second plurality of pieces of content and the related piece of content.

48. A system as recited in claim 43, wherein the evolving metadata context management server device further performs actions comprising:
receiving a search query;
identifying a second plurality of pieces of content based on an index and the search query; and
making available search results including the second plurality of pieces of content and, for at least one of the second plurality of pieces of content, an associated context information.
